(19) United States
(12) Patent Application Publication
(10) Pub. No.: US 2012/0254189 A1
(43) Pub. Date: Oct. 4, 2012

(54) MULTILEVEL INDEXING SYSTEM

(76) Inventor: Biren Narendra Shah, Sunnyvale, CA (US)

(21) Appl. No.: 13/077,367

(22) Filed: Mar. 31, 2011

(51) Int. Cl. G06F 17/30

(52) U.S. Cl. 707/741; 707/E17.002

(57) ABSTRACT

A multilevel indexing system for indexing documents including structure and content information. The system may include a structure index module generating a structure index for the documents based on a document structure. A content index module may generate a content index for the documents based on a document type and document content. A computerized tree generation module may generate a multilevel indexing tree including the structure and content indexes. A search into the structure index may drive a search into the content index.

### BACKGROUND

Search and retrieval of archived documents can require a variety of considerations, such as, the document structure, content, size and location. Enterprise archival solutions are expected to support conflicting needs for semantic functionality in conjunction with high performance, space and cost efficiency, and scalability to several terabytes. In order to improve the search and retrieval performance of archived documents, many commercial systems have employed indexing techniques such as B-trees and inverted files.

Documents can also be represented in eXtensible Markup Language (XML), which is a proposed W3C standard for representing and exchanging information on the Internet. XML documents can be represented in a three-dimensional format including the XML document, document structure (e.g. path), and document word content. For XML type documents, the foregoing indexing techniques however account for only the structure or content associated within a document, but not both. For large collections of XML type documents, the presence of structural information can affect indexing, which can result in inefficient search and retrieval of such documents.

### BRIEF DESCRIPTION OF DRAWINGS

The embodiments are described in detail in the following description with reference to the following figures.

FIG. 1 illustrates a multilevel indexing system according to an embodiment;

FIG. 2 illustrates a multilevel indexing tree structure, according to an embodiment;

FIGS. 3(A)-3(D) illustrate XML document examples, according to an embodiment;

FIGS. 4(A)-4(D) illustrate bucketization, according to an embodiment;

FIG. 5 illustrates a bucket format, according to an embodiment;

FIG. 6 illustrates a multilevel indexing tree, according to an embodiment;

FIG. 7 illustrates a method for multilevel indexing, according to an embodiment;

FIG. 8 illustrates a method for accessing indexed documents, according to an embodiment; and

FIG. 9 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent that the embodiments may be practiced without limitation to all the specific details. Also, the embodiments may be used together in various combinations.

### 1. Overview

Documents such as books, articles, magazines, and generally, any type of information can be represented in a three-dimensional format, namely the document, the document path or structure, and the document word content. A document collection may include millions of documents, a comparably larger number of distinct words, but a limited number of distinct structures compared to the number of documents and distinct words. A high-speed scalable multilevel indexing system (hereinafter “multilevel indexing system”) is provided for indexing and querying of such document collections and accounts for both structure and content information. The multilevel indexing system may include a structure (or tree) index and a content index. For documents represented in a three-dimensional structure based language such as XML, the structure index may be based on XPaths (or path), whereas the content index may be based on documents and words. A XPath expression may be used to navigate through elements and attributes in a XML document. The multilevel indexing system may facilitate efficient structural traversals and may reduce search space through the use of partitioned content indexes. For example, the content indexes may be partitioned based on structural representation of documents, which adds scalability to large document collections. In an embodiment, the search into the structure index may drive the search into the content index, by, for example, invoking, guiding or using previous results to control or implement a search. The multilevel indexing system may be operable with existing content-based indexes, such as B-trees, inverted files, patricia trees or suffix trees.

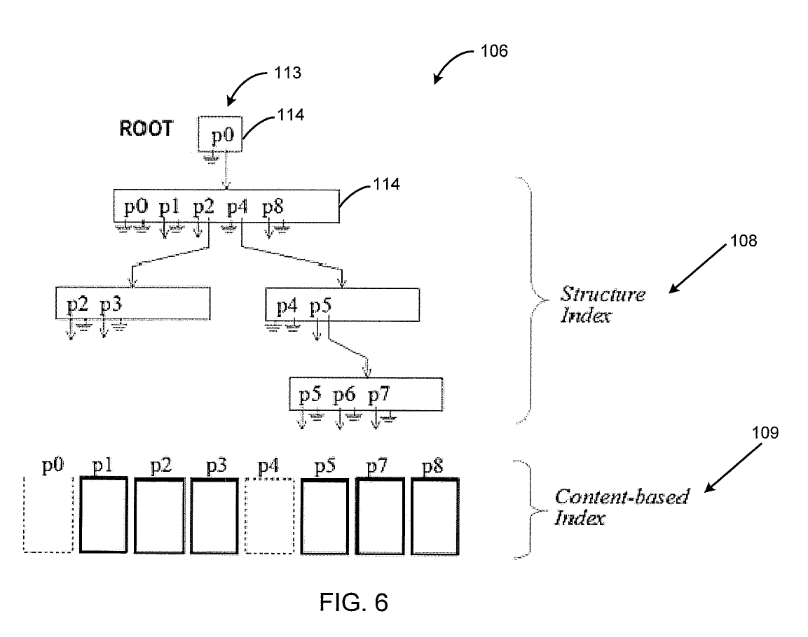

As described in detail below with reference to FIG. 6, in order to provide for efficient XML structure traversal, a multilevel indexing tree may be generated such that adjacent generations (e.g. parent and child nodes) may be bucketized (e.g. grouped together in one bucket). The bucketization may benefit the indexing and search process by allowing the XPaths that are bucketized together to be stored as one family and hence can be accessed from the same bucket. In order to traverse the multilevel indexing tree to locate desired XPaths, as described in detail below, a XPath traversal may be performed by determining an absolute location path, or a relative location path. With the documents indexed based on the structure and content indexes, the multilevel indexing system may thus ascertain a user query, traverse the multilevel indexing tree based on the absolute location path or the relative location path, and generate a query response that outputs the appropriate structure and/or content information. The multilevel indexing system may be used for querying of archived material, or generally, for any application requiring manipulation or querying of structural and content information.

### 2. System

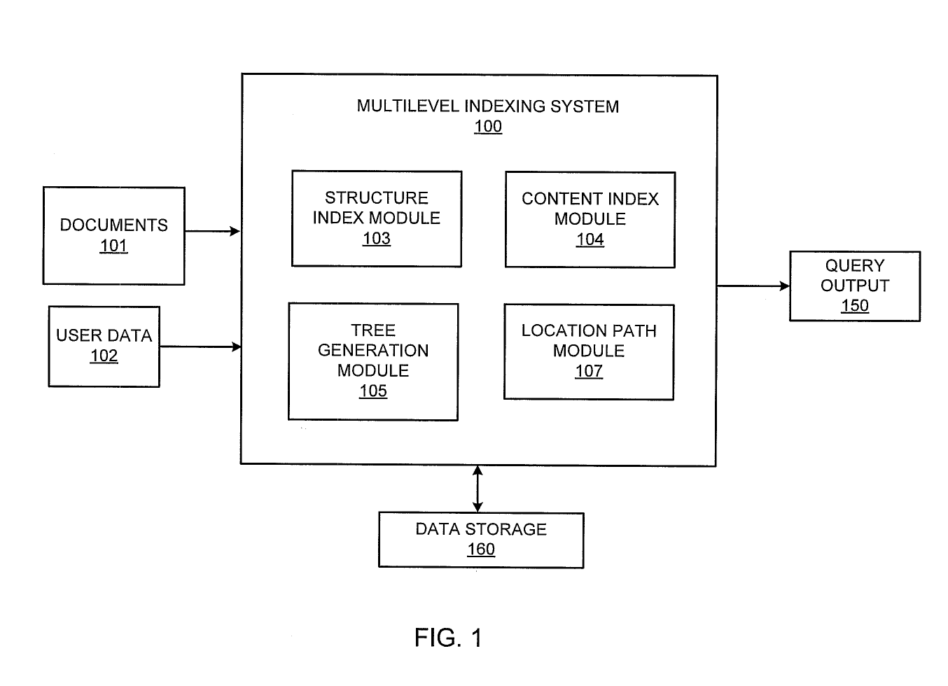

FIG. 1 illustrates a multilevel indexing system 100, according to an embodiment. As shown in FIG. 1, the multilevel indexing system 100 may provide search and retrieval for a collection of documents 101. The documents 101 may include books, articles, magazines, and generally, any type of information that can be stored in a XML format or another equivalent format that accounts for structural and content information. Examples of applications of the system 100 are provided herein for search and retrieval of XML documents. The system 100 may provide for search and retrieval of the XML documents for a query from a user. The user may provide user data 102 that may include queries related to the documents 101 or other information as described below. The system 100 may include a structure index module 103 and a content index module 104 for performing the search as discussed herein. The modules and other components of the system 100 may include machine readable instructions, hardware or a combination of machine readable instructions and hardware. As described in detail below, a tree generation module 105 may generate a multilevel indexing tree 106 for the system 100 as shown in FIG. 6. In order to query the documents 101, a location path module 107 may traverse the multilevel indexing tree 106 to locate desired XPaths. The query results may be generated at query output 150. A data storage 160 may be provided for storing information utilized by the system 100. The data storage 160 may include a database or other type of data management system.

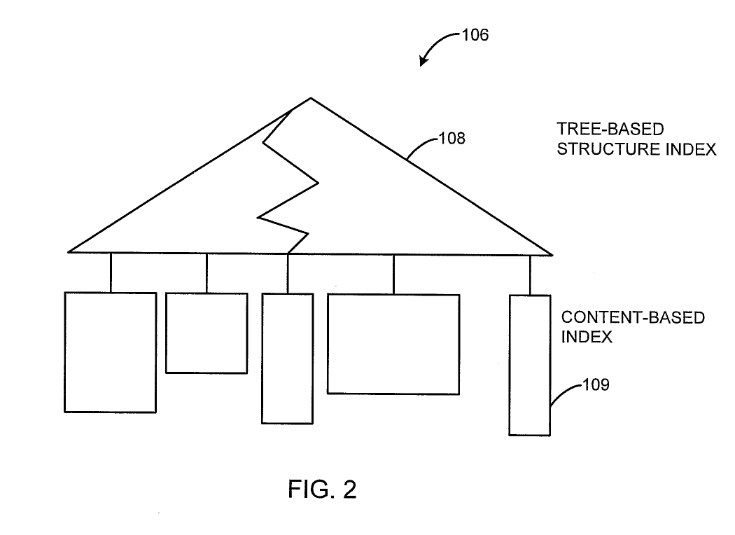

The structure and content index modules 103, 104 for generating structure and content indexes 108, 109, respectively, of the multilevel indexing tree 106 are described with reference to FIGS. 1 and 2.

In order to generate the structure and content indexes 108, 109, the system 100 may first define a collection (e.g. collection-C) 110 of the documents 101, which in the example provided herein are the XML documents. Each document 101 (e.g. document-d) in the collection 110 may contain one or more words 111 (e.g. words-w) that are associated with a XPath 112 (e.g. XPath-p). In an example, system 100 may include one structure index per collection of documents that conform to the same schema, but may include multiple content indexes as discussed herein. For example, for collections of books that include general structural information such as table of contents, chapters, etc., one structure index may be used per collection of books that conform to the same schema. Thus with regard to scalability, the number of structure indexes may remain the same or approximately the same regardless of the addition of books to a document collection, where the books generally conform to the same schema. A XPath expression may be used to navigate through elements and attributes in a XML document. For example, /dblp/inproceedings/author is a XPath expression with “/dblp” as the XML root node, “inproceedings” as the child node of the root node, and “author” corresponds to the authors of the dblp proceedings. In an embodiment, the collection-C may be defined as C={(d,p,w)}. In order to represent a two-dimensional index for three-dimensional XML documents, the collection-C defined as (d,p,w) may be allocated into either ((p,w),d) or (p,(d,w)). For the collection-C allocated into ((p,w),d), a multi-key index of (p,w) addresses a partition {d} of the collection. This allocation may have scalability limitations since the first index (p,w), driving the search into the second index {d}, may become excessively large for very large document collections. This approach may also have drawbacks due to limitations in available memory for handling increases in document collections. For the collection-C allocated into (p,(d,w)), the XPath-p may direct a partition {(d,w)}.

Referring to FIGS. 1 and 2, the modules 103, 104 may allocate the collection-C into (p,(d,w)). This allocation may provide for interoperation with existing content-based indexes, such as B-trees, inverted files, patricia trees or suffix trees. For example, a B-tree index may have suitability for range queries (e.g. obtain everything between x to y). Alternatively, a hash index may have suitability for equality queries (e.g. obtain everything with value x), but not particular suitability for range queries as is the case for B-tree indexes. Thus based on the allocation of the collection-C into (p,(d,w)), a different type of content index may be used with a particular type of structural element. The allocation of the collection-C into (p,(d,w)) may also provide for efficiency and scalability to searches that include multi-step traversals. As shown in FIG. 2, allocation of the collection-C into (p,(d,w)) may include the upper layer structure index 108 based on paths. The structure index 108 may include a tree-based structure that can facilitate efficient XPath traversal. Allocation of the collection-C into (p,(d,w)) may further include the lower layer content index 109 based on documents and words.

The framework of multilevel indexing system 100 is described with reference to FIGS. 1-6.

Referring to FIGS. 2-4, the structure index 108 may be denoted as I(p) for the document collection-C, where C={(d,p,w)} is given by I(p)=(V,E,T). The expression I(p)=(V,E,T) may include a root node 113 (e.g. node-T), buckets 114 (e.g. buckets-V) that contain the XPaths 112, and edges-E 115 (e.g. edges−E) that connect two buckets-V. A bucket-V may be defined as an ordered list of n XPaths, (lᵢ,pᵢ,rᵢ), for pᵢ ∈ P where l=0, . . . , n−1, lᵢ and rᵢ are left and right pointers respectively pointing to a partitioned content-based index and sub-bucket. Each bucket-V may include the XPath-p with all pᵢ such that the least common ancestor of pᵢ and p is p, for all child pᵢ.

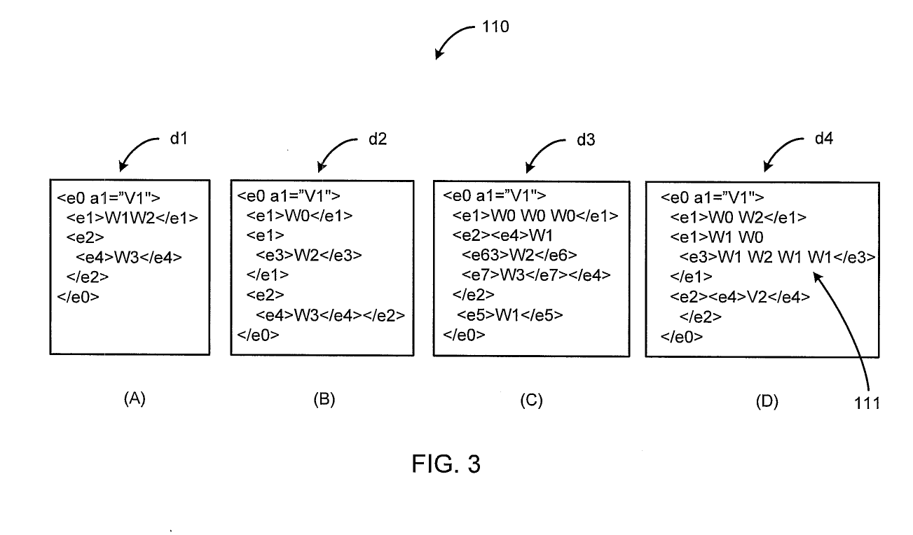

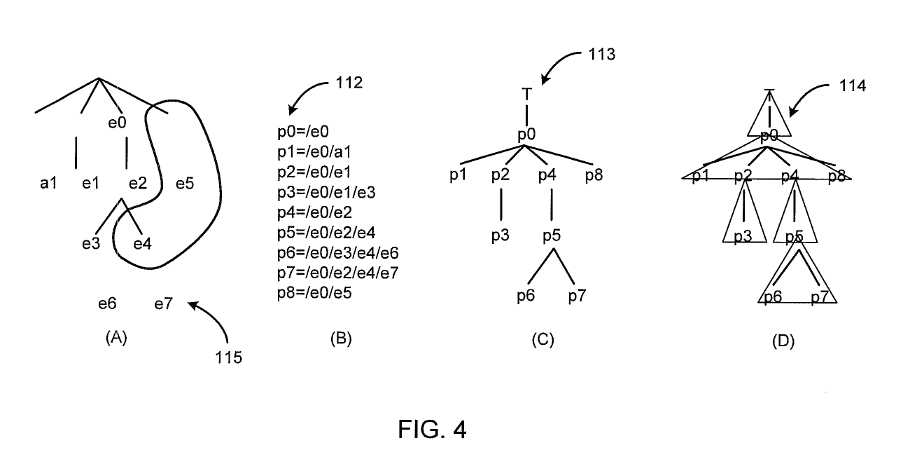

For example, considering the four XML documents 101 (d1, d2, d3, d4) in FIG. 3, a data graph is shown in FIG. 4(A). Referring to FIG. 4(B), for a given set of the XPaths-p which are extracted from a collection of XML documents, a partial-ordering may be constructed as shown in FIG. 4(C). For two XPaths p₁ and p₂, if p₁ [symbol] p₂, p₂ is considered more general than p₁. For example, if p₁=/dblp/inproceedings/author and p₂=/dblp/inproceedings, then p₁ [symbol] P2. In this case, p₂ may be denoted an ancestor of p₁, and p₁ may be denoted a descendant of p₂. Thus, [symbol] may impose a partial ordering on the path expression, and is transitive. The XPaths-p may be bucketized in one bucket if the XPaths-p are in one family (parent XPath together with its child XPaths form a single family). For example, referring to FIG. 4(D), the XPaths-p p5, p6 and p7 form a single family.

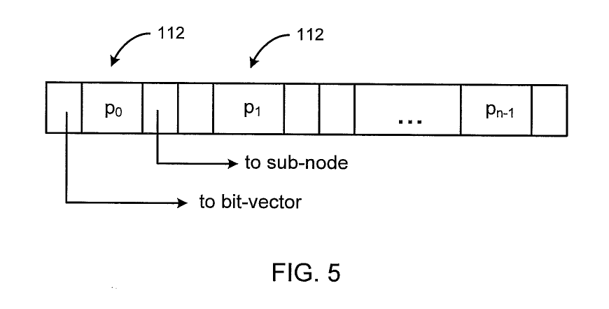

Referring to FIG. 5, the format of a bucket node in the system 100 is shown. Each bucket-V may contain n XPaths-p, p₀, p₁, p₁, . . . , pₙ₋₁, with 2n pointers. The first XPath-p p₀ may be the parent of all pᵢ, for i=1, . . . , n−1. Since the XPaths-p are numbered in pre-order, the XPaths-p in each bucket may be sorted. For example, if 0<i<j, then pᵢ<pⱼ (e.g. p₁ is the first child, followed by p₂, and pₙ₋₁ is last child). Each XPath-p in a bucket may have two pointers, lᵢ and rᵢ, as described above. The tree generation module 105 may generate the multilevel indexing tree 106 for the system 100 as shown in FIG. 6. For the multilevel indexing tree 106, each bucket-V may contain a parent XPath node with all its child XPath nodes. For example, the root node 113 may be bucketized together with p0 in level 1, and p0 may again be bucketized together with p1, p2, p4 and p8 in level 2. Similarly, p2 may be bucketized with p3 and so on. Bucketization may benefit the indexing and search process by allowing the XPaths-p that are bucketized together to be stored as one family and hence provide accessibility from same bucket. Further, bucketization may benefit the indexing and search process with regard to the cost of traversal between a parent and its children. For example, since two adjacent generations appear in one bucket, the cost of traversal between a parent and its children, and the traversal among children is zero.

Referring to FIG. 6, in order to locate the XPath 112 efficiently and effectively and then link the XPath 112 to the content index 109, a bucket (lᵢ,pᵢ,rᵢ) in the multilevel indexing tree 106 may include a XPath pᵢ, a left pointer pᵢ.lᵢ, and a right pointer pᵢ.rᵢ of pᵢ. For the foregoing bucket (lᵢ,pᵢ,rᵢ), if pᵢlᵢ=NULL, then pᵢ is a XPath having no direct content associated with it. For example, p0 and p4 in FIG. 6 have no direct content associated with them. If pᵢ.rᵢ≠0 NULL, then pᵢ is a parent node of all XPaths pⱼ∀j≠i, in a sub-bucket. For example, p2 is parent of p3 in FIG. 6. Further, the number of XPaths n in a bucket may be less than n_{B}/(2nₜ+nₚ), where n_{B}, nₜ, nₚ denote the size of the bucket, pointer, and XPath, respectively. If the bucket size exceeds the capacity n_{B} of a bucket, then an overflow bucket may be provided.

The foregoing properties of the multilevel indexing tree 106 provide a framework for representing the structural information associated with a XML document collection. In an example, the framework provides bucketizing of XPath elements from adjacent generations to facilitate efficient traversals between paths that belong to one family. The foregoing properties may also preserve structural information in a document tree.

The location of the XPath 112 is described with reference to FIGS. 1-6.

In order to traverse the multilevel indexing tree 106 to locate desired XPaths, a Xpath traversal may be performed by the location path module 107 that may determine the absolute location path, or the relative location path. An absolute location path may include the full path from the root. An absolute location path may be further classified as either absolute full location path or absolute partial location path traversals. For an absolute full location path, the traversal may begin at a /, which is the root element and end with the desired descendant element. Since this technique uses the complete path, starting with the root element, this technique may be referred to as the absolute location path. The absolute location path may facilitate selection of a specific element in the XML structure hierarchy. For example, the XPath expression p_{q1}=/dblp/inproceedings/author is an absolute full location path. For an absolute partial location path, the path may start from the node selected by the user. Thus the path may not have to begin from the root node. For example, the XPath expression p_{q2}=//booktitle is an absolute partial location path. Absolute full or absolute partial location path queries may access the structure index 108. An example of such a query may include, “does the XPath/dblp/inproceedings/author exist in the XML document collection”? Absolute full or absolute partial location path queries may also access the structure index 108 and the content index 109. An example of such a query may include, “return all documents/publications with ‘Ronald Maier’ as the author of the proceedings”.

With regard to the relative location path, a full axis traversal of the multilevel indexing tree 106 may be implemented. For example, the user may also query another axes, such as, ancestors (parent/child), or siblings (following/preceding). For example, the XPath expression p_{q3}=/dblp/inproceedings/author/following-sibling::booktitle returns the booktitle found in the sibling node of the context node represented by /dblp/inproceedings/author. Thus this XPath expression may return the title of the book authored by the author corresponding to the context node. Relative location path queries may access the structure index 108. An example of such a query may include, “return all siblings of /dblp/inproceeding/author”. Relative location path queries may also access the structure index 108 and the content index 109. An example of such a query may include, “return the publication year and title of all books authored by ‘Ronald Maier’”.

Depending on the characteristics of the XPaths-p specified in a query, the procedure for locating a XPath may differ accordingly. For example, absolute (full and partial) location paths may traverse in a forward direction from a root bucket. Relative location paths may begin by traversing forward from the root to locate the context node and then possibly further, in both backward and forward directions, from the context node to locate the target node.

The system 100 may facilitate backward traversals in the case of locating relative location paths. For example, for relative location XPath expressions querying the ancestor or the sibling axes of the context node, the target node may be accessed in the same bucket as the context node without requiring any backward traversals (since these nodes form a family and hence are bucketized in the same bucket).

### 3. Method

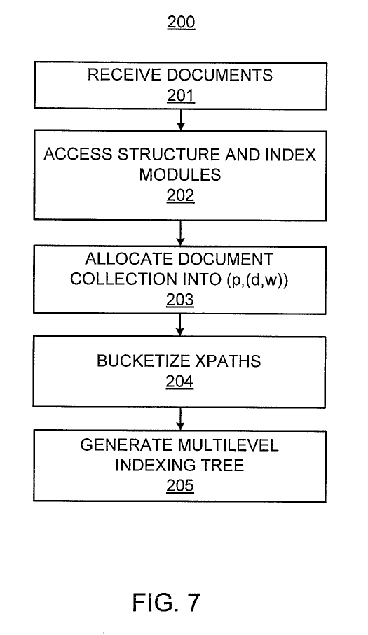

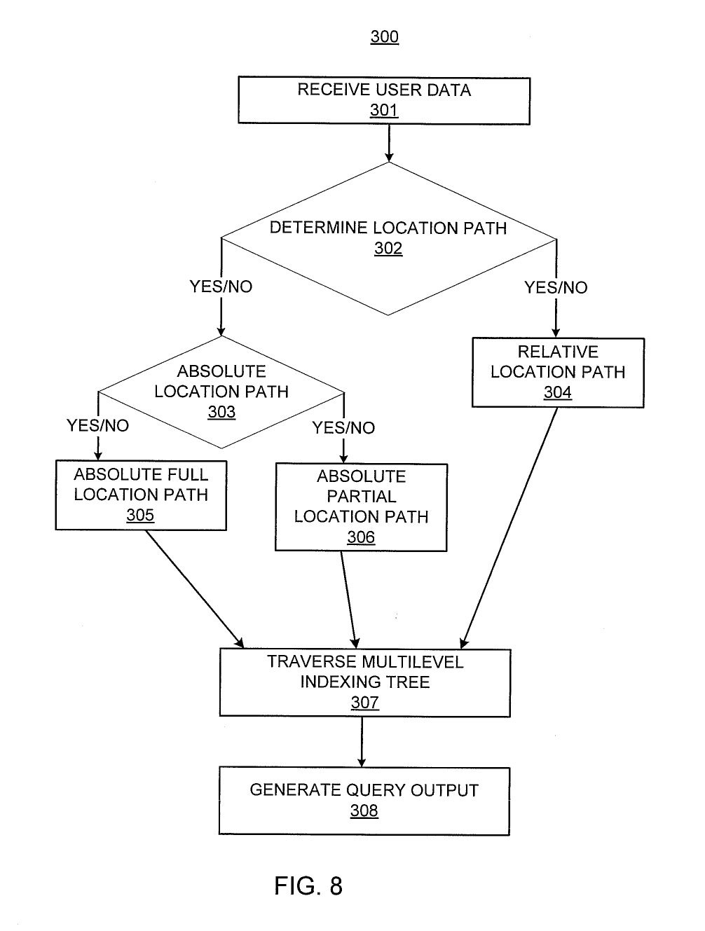

FIG. 7 illustrates a method 200 for multilevel indexing, according to an embodiment. FIG. 8 illustrates a method 300 for accessing the documents 101 that have been indexed by the multilevel indexing system 100, according to an embodiment. The methods 200 and 300 are described with respect to the multilevel indexing system 100 shown in FIGS. 1-6 by way of example and not limitation. The methods 200 and 300 may be performed by other systems.

As shown in FIG. 7, in order to index the documents 101, at block 201, the multilevel indexing system 100 may receive the documents 101.

At block 202, the system 100 may access the structure and content index modules 103, 104 for setting up the structure and content indexes 108, 109, respectively, of the multilevel indexing tree 106. As described above, in order to set up the structure and content index 108, 109, the system 100 may first define the collection 110 (e.g. collection-C) of the XML documents. Each document 101 (document-d) in the collection 110 may contain one or more words 111 (e.g. words-w) that are associated with the XPath 112 (e.g. XPath-p). As described above, the XPath expression may be used to navigate through elements and attributes in a XML document. For example, /dblp/inproceedings/author is a XPath expression with “/dblp” as the XML root node, “inproceedings” as the child node of the root node, and “author” corresponds to the authors of the dblp proceedings. In an embodiment, the collection-C may be defined as C={(d,p,w)}. In order to represent a two-dimensional index for three-dimensional XML documents, the collection-C defined as (d,p,w) may be allocated into either ((p,w),d) or (p,(d,w)). As described above, for the collection-C allocated into ((p,w),d), a multi-key index of (p,w) addresses a partition {d} of the collection. This allocation has scalability limitations since the first index (p,w), driving the search into the second index {d}, may get excessively large for very large document collections. This approach may also have drawbacks due to limitations in available memory for handling increases in document collections. For the collection-C allocated into (p,(d,w)), the XPath-p may direct a partition {(d,w)}.

At block 203, referring to FIGS. 1 and 2, the modules 103, 104 may allocate the collection-C into (p,(d,w)). This allocation provides for interoperation with existing content-based indexes. This allocation may also provide for efficiency and scalability to searches that may include multi-step traversals. As shown in FIG. 2 and described above, allocation of the collection-C into (p,(d,w)) may include the upper layer structure index 108 based on paths. The structure index 108 may include a tree-based structure that can facilitate efficient XPath traversal. Allocation of the collection-C into (p,(d,w)) may further include the lower layer content index 109 based on documents and words.

At block 204, referring to FIGS. 2-4, in order to bucketize the XPaths 112, the structure index 108 may be denoted as I(p) for the document collection-C, where C={(d,p,w)} is given by I(p)=(V,E,T). The expression I(p)=(V,E,T) may include the root node 113 (e.g. node-T), the buckets 114 (e.g. buckets-V) that contain the XPaths 112, and the edges-E 115 (e.g. edges-E) that connect two buckets-V. As described above, a bucket-V may be defined as an ordered list of n XPaths, (lᵢ,pᵢ,rᵢ), for pᵢ ∈ P where i=0, . . . , n−1, lᵢ and rᵢ are left and right pointers respectively pointing to a partitioned content-based index and sub-bucket. Each bucket-V may include the XPath-p with all pᵢ, such that least common ancestor of pᵢ and p is p, for all child pᵢ. For example, considering the four XML documents 101 (d1, d2, d3, d4) in FIG. 3, a data graph is shown in FIG. 4(A). Referring to FIG. 4(A), for a given set of the XPaths-p which are extracted from a collection of XML documents, a partial-ordering may be constructed as shown in FIG. 4(C). As described above, for two XPaths p₁ and p₂, if p₁ [symbol] p₂, p₂, p₂ is considered more general than p₁. For example, if p₁=/dblp/inproceedings/author and p₂=/dblp/inproceedings, then p₁ [symbol] p₂. In this case, p₂ may be denoted an ancestor of p₁ and p₁ may be denoted a descendant of p₂. Thus, [symbol] imposes a partial ordering on the path expression, and is transitive. The XPaths-p may be bucketized in one bucket if the XPaths-p are in one family (parent XPath together with its child XPaths form a single family). For example, referring to FIG. 4(D), the XPaths-p p5, p6 and p7 form a single family. Referring to FIG. 5, the format of a bucket node in the system 100 is shown. As described above, each bucket-V may contain n XPaths-p, p₀, p₁, . . . , pₙ₋₁, with 2n pointers. The first XPath-p p₀ may be the parent of all pᵢ, for i=1, . . . , n−1. Since the XPaths-p are numbered in pre-order, the XPaths-p in each bucket may be sorted. For example, if 0<i<j, then pᵢ<pⱼ (e.g. p₁ is the first child, followed by p₂, and pₙ₋₁ is last child). Each XPath-p in a bucket may have two pointers, and as described above.

At block 205, the system 100 may generate the multilevel indexing tree 106 shown in FIG. 6. For the multilevel indexing tree 106, each bucket-V may contain a parent XPath node with all its child XPath nodes. For example, the root node 113 may be bucketized together with p0 in level 1, and p0 is again bucketized together with p1, p2, p4 and p8 in level 2. Similarly, p2 may be bucketized with p3 and so on. As described above, bucketization may benefit the indexing and search process by allowing the XPaths-p that are bucketized together to be stored as one family and hence accessed from same bucket. Further, bucketization may benefit the indexing and search with regard to the cost of traversal between a parent and its children. For example, since two adjacent generations appear in one bucket, the cost of traversal between a parent and its children, and the traversal among children is zero. Referring to FIG. 6, in order to locate a XPath 112 efficiently and effectively and then link the XPath 112 to the content index 109, a bucket (lᵢ,pᵢ,rᵢ) in the multilevel indexing tree 106 may include a XPath pᵢ, a left pointer pᵢ,lᵢ, and a right pointer pᵢ,rᵢ of pᵢ. For the foregoing bucket (lᵢ,pᵢ,rᵢ), if pᵢlᵢ=NULL, then pᵢ is a XPath having no direct content associated with it. For example, p0 and p4 in FIG. 6 have no direct content associated with them. If pᵢ,rᵢ≠NULL, then pᵢ is a parent node of all XPaths pⱼ∀j≠i, in a sub-bucket. For example, p2 is the parent of p3 in FIG. 6. Further, the number of XPaths n in a bucket may be less than n_{B}/(2nₜ+nₚ), where n_{B}, nₜ, nₚ denote the size of the bucket, pointer, and XPath, respectively. If the bucket size exceeds the capacity n_{B} of a bucket, then an overflow bucket may be provided. The foregoing properties of the multilevel indexing tree 106 provide a framework for representing the structural information associated with a XML document collection. Bucketizing of XPath elements from adjacent generations thus facilitates efficient traversals between paths that belong to one family. The foregoing properties also preserve structural information in a document tree.

The method 300 for accessing the documents 101 that have been indexed by the multilevel indexing system 100 is now described with reference to FIG. 8.

Referring to FIG. 8, in order to process a search and retrieval for a collection of the documents 101, at block 301, the multilevel indexing system 100 may receive the user data 102 from a user including queries related to the documents 101 or other information as described herein.

At block 302, upon receipt of a query from the user, in order to traverse the multilevel indexing tree 106 to locate desired XPaths, the location path module 107 may determine based on the query the absolute location path at block 303, or the relative location path at block 304.

At block 303, for the absolute location path, module 107 may further classify the location path as either absolute full location path traversal at block 305 or absolute partial location path traversal at block 306.

At block 307, for an absolute full location path (block 305), the traversal of the multilevel indexing tree 106 may begin at a /, which is the root element and end with the desired descendant element. Since this method uses the complete path, starting with the root element, this method is referred to as the absolute location path. The absolute location path may facilitate selection of a specific element in the XML structure hierarchy. For example, the XPath expression p_{q1}=/dblp/inproceedings/author is an absolute full location path. Similarly, at block 307, for an absolute partial location path (block 306), the traversal of the multilevel indexing tree 106 may start from the node selected by the user. Thus the path may not have to begin from the root node. For example, the XPath expression p_{q2}=//booktitle is an absolute partial location path. Absolute full or absolute partial location path queries may access structure index 108. An example of such a query may include, “does the XPath /dblp/inproceedings/author exist in the XML document collection”? Absolute full or absolute partial location path queries may also access structure index 108 and content index 109. An example of such a query may include, “return all documents/publications with ‘Ronald Maier’ as the author of the proceedings”.

Referring again to block 304, for the relative location path, a full axis feature traversal of the multilevel indexing tree 106 may be implemented at block 307. For example, the user may also query another axes, such as, ancestors (parent/child), or siblings (following/preceding). For example, the XPath expression p_{q3}=/dblp/inproceedings/author/following-sibling::booktitle returns the booktitle found in the sibling node of the context node represented by /dblp/inproceedings/author. Thus this XPath expression returns the title of the book authored by the author corresponding to the context node. Relative location path queries may access structure index 108. An example of such a query may include, “return all siblings of /dblp/inproceeding/author”. Relative location path queries may also access structure index 108 and content index 109. An example of such a query may include, “return the publication year and title of all books authored by ‘Ronald Maier’”.

At block 308, the query results may be generated at query output 150.

### 4. Computer Readable Medium

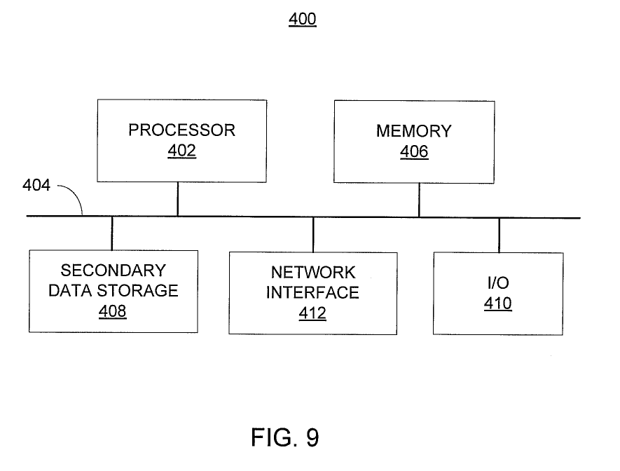

FIG. 9 shows a computer system 400 that may be used with the embodiments described herein. The computer system 400 represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

What is claimed is:

1. A multilevel indexing system for indexing documents including structure and content information, the system comprising:
a structure index module generating a structure index for at least one of the documents based on a document structure;
a content index module generating a content index for at least one of the documents based on a document type and document content; and
a computerized tree generation module generating a multilevel indexing tree including the structure and content indexes, wherein a search into the structure index drives a search into the content index.

2. The system of claim 1, wherein at least one of the documents is a XML format document.

3. The system of claim 2, wherein the document structure is a XPath used to navigate through elements and attributes in the XML format document.

4. The system of claim 1, wherein the structure and content indexes are based on an assignment of a collection of the documents into (p,(d,w)), where the structure index is based on the document structure denoted structure-p, and the content index is based on the document type denoted type-d and the document content denoted content-w, such that the search into the structure index drives the search into the content index.

5. The system of claim 4, wherein assignment of the collection of the documents into (p,(d,w)) provides for operation of the structure index with a plurality of content indexes.

6. The system of claim 1, wherein the system includes one structure index per collection of the documents that conform to a same schema.

7. The system of claim 1, wherein the structure index includes at least one bucket containing a parent structure node with a corresponding child structure node.

8. The system of claim 3, wherein the structure index includes at least one bucket containing a parent XPath with a corresponding child XPath.

9. The system of claim 1, further comprising a location path module for traversing the multilevel indexing tree, the location path module determining an absolute location path or a relative location path based on a query.

10. The system of claim 9, wherein the absolute location path includes an absolute full location path that traverses the multilevel indexing tree from a root element and ends with a desired descendant element, or an absolute partial location path that starts from an element selected by a user.

11. The system of claim 9, wherein the relative location path traverses the multilevel indexing tree in forward or backward directions from an element selected by a user to a target element.

12. A method for indexing documents including structure and content information, the method comprising:
generating a structure index for at least one of the documents based on a document structure;
generating a content index for at least one of the documents based on a document type and document content; and
generating, by a computer, a multilevel indexing tree including the structure and content indexes, wherein a search into the structure index drives a search into the content index.

13. The method of claim 12, wherein at least one of the documents is a XML format document.

14. The method of claim 13, further comprising using a XPath to navigate through elements and attributes in the XML format document.

15. The method of claim 12, further comprising assigning a collection of the documents into (p,(d,w)), where the structure index is based on the document structure denoted structure-p, and the content index is based on the document type denoted type-d and the document content denoted content-w, such that the search into the structure index drives the search into the content index.

16. The method of claim 15, further comprising operating the structure index with a plurality of content indexes based on assignment of the collection of the documents into (p,(d,w)).

17. The method of claim 12, wherein the structure index includes at least one bucket containing a parent structure node with a corresponding child structure node.

18. The method of claim 14, wherein the structure index includes at least one bucket containing a parent XPath with a corresponding child XPath.

19. The method of claim 12, further comprising traversing the multilevel indexing tree based on an absolute location path or a relative location path based on a query.

20. A non-transitory computer readable medium storing machine readable instructions, that when executed by a computer system, perform a method for indexing documents including structure and content information, the method comprising:
generating a structure index for at least one of the documents based on a document structure;
generating a content index for at least one of the documents based on a document type and document content; and
generating, by a computer, a multilevel indexing tree including the structure and content indexes, wherein a search into the structure index drives a search into the content index.
